(19) United States
(12) Patent Application Publication
(10) Pub. No.: US 2018/0308060 A1
(43) Pub. Date: Oct. 25, 2018

(54) JOINT ASSIGNMENT OF MEMBER PROFILES TO JOB POSTINGS

(71) Applicant: LinkedIn Corporation, Sunnyvale, CA (US)

(72) Inventors: Krishnaram Kenthapadi, Sunnyvale, CA (US); Bo Zhao, Redwood City, CA (US)

(21) Appl. No.: 15/495,049

(22) Filed: Apr. 24, 2017

(51) Int. Cl. G06Q 10/10; G06Q 50/00

(52) U.S. Cl. CPC G06Q 10/1053; G06Q 50/01

(57) ABSTRACT

An on-line social network system includes or is in communication with a recommendation system that is configured to assign jobs to members and member profiles to jobs simultaneously. While generating and refining lists of member profiles representing potentially qualified candidates for filling jobs represented by respective job postings for members, the recommendation system takes into consideration respective job cap values for the member profiles that have been included in the respective lists of candidate profiles and, if it determines that a member would be recommended for more jobs than the jobs cap value, it removes the reference to that member profile from one or more presentation sets of profiles based on the fitness values assigned to that member profile with respect to job postings for which the presentation sets of profiles were generated.

### TECHNICAL FIELD

This application relates to the technical fields of software and/or hardware technology and, in one example embodiment, to system and method to generate joint assignment of member profiles to job postings in an on-line social network system.

### BACKGROUND

An on-line social network may be viewed as a platform to connect people and share information in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An on-line social network may store include one or more components for matching member profiles with those job postings that may be of interest to the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate joint assignment of member profiles to job postings in an on-line social network system may be implemented;

FIG. 2 is block diagram of a system to generate joint assignment of member profiles to job postings in an on-line social network system, in accordance with one example embodiment;

FIG. 3 is a flow chart illustrating a method to generate joint assignment of member profiles to job postings in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate joint assignment of member profiles to job postings in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application,” “an on-line social network system,” and “an on-line social network service” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may include or be associated with links that indicate the member's connection to other members of the social network. A member profile may also include or be associated with comments or recommendations from other members of the on-line social network, with links to other network resources, such as, e.g., publications, etc. The profile information of a social network member may include various information such as, e.g., the name of a member, current and previous geographic location of a member, current and previous employment information of a member, information related to education of a member, etc. The on-line social network system also maintains information about various companies, as well as so-called job postings. A job posting, also referred to as merely “job” for the purposes of this description, is an electronically stored entity that includes information that an employer may post with respect to a job opening.

The information in a job posting may include, e.g., industry, company, job position, required and/or desirable skills, geographic location of the job, etc. Member profiles and job postings are represented in the on-line social network system by feature vectors. The features in the feature vectors may represent, e.g., a job industry, a professional field, a job title, a company name, professional seniority, geographic location, etc.

The on-line social network system includes a recommendation system configured to select one or more job postings for presentation to a member based on criteria that indicates that a particular job posting is likely to be of interest to the member. The likelihood of a job being of interest to a member, in one embodiment, is expressed by the probability of the member applying for the associated job. The criteria that indicates that a particular job posting is likely to be of interest to the member, in one embodiment, is associated with a relevance value.

When a new login session is initiated for a member in the on-line social network system, the recommendation system generates respective relevance values for pairs comprising a member profile representing the member in the on-line social network system and a job posting. The relevance values, in one embodiment, are generated using a statistical model (referred to as the relevance model for the purposes of this description). Those job postings, for which their respective relevance values for a particular member profile are equal to or greater than a predetermined threshold value, are selected for potential presentation to that particular member, e.g., on the news feed page of the member or on some other page provided by the on-line social networking system.

While the recommendation system generates job recommendations for members, the recommendation system is also configured to identify, with respect to a particular job posting, those members that are potentially qualified for the job. Thus it can be said that the recommendation system generates job recommendations with respect to a member profile and also generates member recommendations with respect to a job posting.

Member recommendations for a job postings are selected based on their respective fitness values. A fitness value generated for a member profile with respect to a job posting indicates how qualified the member represented by the member profile is for the job represented by the job posting. A fitness value, in one embodiment, is expressed by the probability of the member being hired for the job. Respective fitness values for pairs comprising a member profile and a job posting can be generated using a statistical model (referred to as the fitness model for the purposes of this description). It will be noted that, for the purposes of this description, when discussing items in a presentation set of job recommendations or items in a presentation set of profiles, the phrase “member” or “member profile” refers to a reference to a member profile, and the phrase “job” or “job posting” refers to a reference to a job posting.

As the number of jobs potentially relevant to a member may be too large for the presentation real estate and the member's attention span, the recommendation system uses a cap value r(m) (termed a jobs cap value) that limits the maximum number of jobs that can be included in a presentation set of job recommendations for a particular member profile m. For the purposes of this description, a member profile is sometimes referred to as merely member. Also, the number of member profiles to be recommended with respect to a particular job posting j is limited by a so-called candidates cap value, s(j) such that the number of items that can be included in a presentation set of profiles is less than or equals to that value. Each item in a presentation set of job recommendations is a reference to a job posting that is associated with a relevance value generated for that job posting with respect to the particular member. The items in the presentation set of job recommendations may be ordered based on their respective associated relevance values. Each item in a presentation set of profiles generated for a particular job posting is a reference to a member profile that is associated with a fitness value generated for that member profile with respect to the particular job postings. The items in the presentation set of profiles may be ordered based on their respective associated fitness values.

In one embodiment, the recommendation system assigns jobs to members and member profiles to jobs simultaneously. Specifically, while generating and refining sets of candidate profiles to recommend with respect to a job posting, the recommendation system takes into consideration the jobs cap value r(m) and, if it determines (by examining respective sets of candidate profiles generated for job postings) that a member profile would be recommended as a good fit for more job postings than the jobs cap value, it removes the reference to that member profile from one or more sets of candidate profiles based on the associated fitness values. Also, when an item has been removed from a set of candidate profile for a particular job posting, and as a consequence the number of items in the set is now less than the candidates cap value, the recommendation system may add a reference to a different member profile into the set, e.g., a reference to a member profile that has been identified as potentially fitting the requirements of the job posting but that was not initially included in the presentation set of profiles because of the size of set limitation expressed by the candidates cap value.

Simultaneous assignment of this nature may prove to be beneficial since it takes into account the fitness of a member for a particular job as well as how relevant the job is for that member. In particular, such assignment ensures that the same member profile does not get recommended for a very large set of jobs, as not all potentially qualified members are likely to actually apply for the job, judging from their level of interest expresses by the associated relevance value.

In operation, the recommendation system generates, for each member profile in a set of member profiles, a presentation set of job recommendations. The recommendation system also generates, for each job posting in a set of job postings, a presentation set of profiles. Any such presentation set of job recommendations has no more items than the jobs cap value, and any such presentation set of profiles has no more items than the candidates cap value. With the presentation set of job recommendations and the sets of candidate profiles in place, the recommendation system may determine, for example, that the number of job postings associated with respective presentation sets of profiles that include a particular member profile is greater than the cap jobs value. As explained above, each item in a presentation set of profiles is associated with a respective fitness value, so that the recommendation system can be configured to identify a target job posting, where the particular member profile in the presentation set of profiles has the lowest associated fitness value, as compared to the respective fitness values assigned to that particular member profiles in other presentation sets of profiles, and remove an item from that presentation set of profiles. The recommendation system then adds to the presentation set of profiles generated for the target job posting (that now has in it at least one item fewer that the candidate cap value) a reference to a different member profile that has been identified as potentially qualified for the job represented by the target job posting but that was not initially included in the presentation set of profiles because of the size of set limitation expressed by the candidates cap value.

Another way to describe the method for simultaneous assignment of qualified member recommendations to jobs posted in a professional social network is provided below.

The recommendation system takes, as input, (1) the maximum number of job recommendations, r(m), desirable for each member profile m, (2) the maximum number of member recommendations, s(j) desirable for each job posting j, and (3) the time period, deltaT, between two adjacent joint computations.

At time t, for each member profile m, the recommendation system determines jobRank(m), a ranked set of job recommendations, as follows. It first obtains a preliminary set of job postings, using, e.g., the candidate selection system in the recommendation system based on the feature comparison approach. The recommendation system then scores each job posting in the set using the relevance model, and retains, for inclusion in the ranked set of job recommendations, those job postings that have respective relevance values greater than a predetermined minimum score threshold. The recommendation system then generates a set of job recommendations of (up to) top k jobs based on their respective relevance values, where k is a predetermined threshold that is usually greater than r(m).

The recommendation system also generates a ranked set of candidate members for each job posting. At time t, for each job posting j, the recommendation system determines memberRank(j), a ranking of top member profiles, as follows. It obtains a preliminary candidate set of member profiles, using, e.g., the candidate selection system in the recommendation system based on feature comparison. Each item in the preliminary candidate set of member profiles is assigned a respective fitness value using a fitness model, and retains, for inclusion in the set of candidate profiles, references to those profiles that have respective fitness values greater than a predetermined minimum score threshold. The resulting set of candidate profiles is a ranked list of (up to) top k members based on their respective fitness values, where k is a predetermined threshold that is usually greater than s(j).

The recommendation system then proceeds with joint assignment of qualified member recommendations to jobs, as follows.

At time t, let s′(j)=min(s(j), |memberRank(j)|). Each job posting j is initially assigned s′(j) highest ranked member profiles (that is, member profiles that have been assigned the highest fitness values as compared to fitness values assigned to other member profiless with respect to job posting j) from the set of member profiles, memberRank(j), and these member profiles are removed from the list memberRank(j).

Let r′(m)=min(r(m), |jobRank(m)|). If a member profile m has been assigned to more than r′(m) job postings, the assignment is limited to the r′(m) assigned job postings that rank highest according to the list, jobRank(m), and the reference to member profile m is removed from the remaining members.

Each job posting j with s″(j)<s′(j) job assignments (resulting from the previous operation) then gets assigned (up to) s′(j)−s″(j) member profiles having the top fitness values remaining in memberRank(j).

At this point in the simultaneous assignment process, the assignment of a given member profile to job postings is limited to the r′(m) of highest ranked assigned job postings; the references to the given member profile is removed from the presentation sets of profiles generated for other, remaining, job postings. The process continues until each job posting j has been assigned s′(j) jobs or memberRank(j) is empty (that is, all these member profiles have been considered for assignment to job posting j).

The process of simultaneous assignment of jobs to members and member profiles to jobs can be repeated at intervals of deltaT in order to take into account the temporal nature of members and jobs (new members/members who updated their profiles/new jobs/expired jobs/edited jobs). Between a computation and the next one, the member profile recommendations for job postings are computed for each job posting separately, using a fitness model.

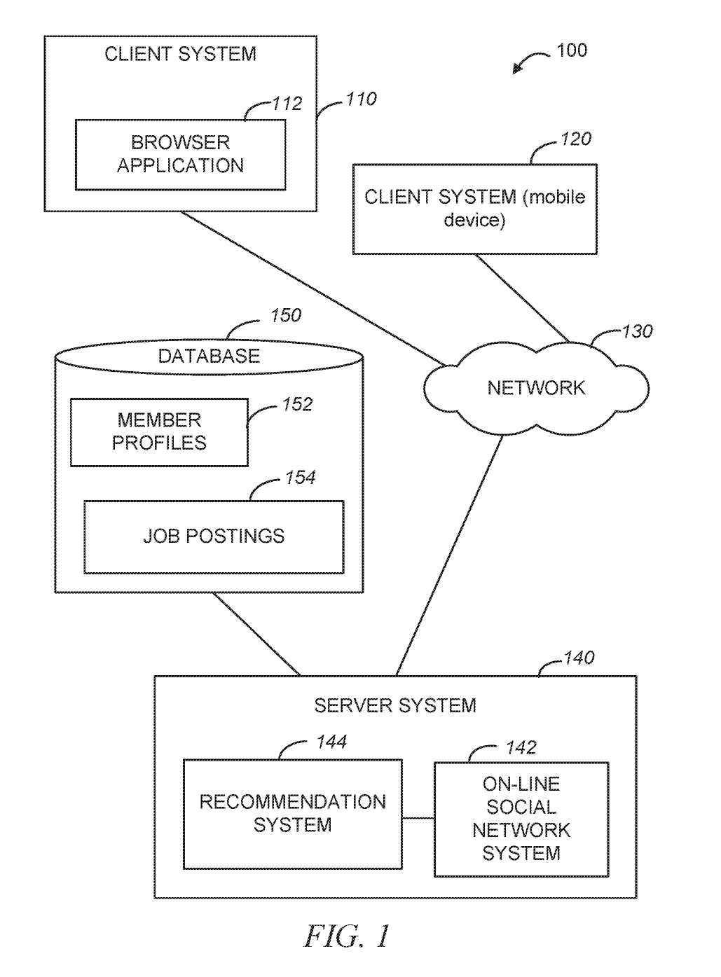

An example recommendation system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152. The database 150 also stores job postings 154.

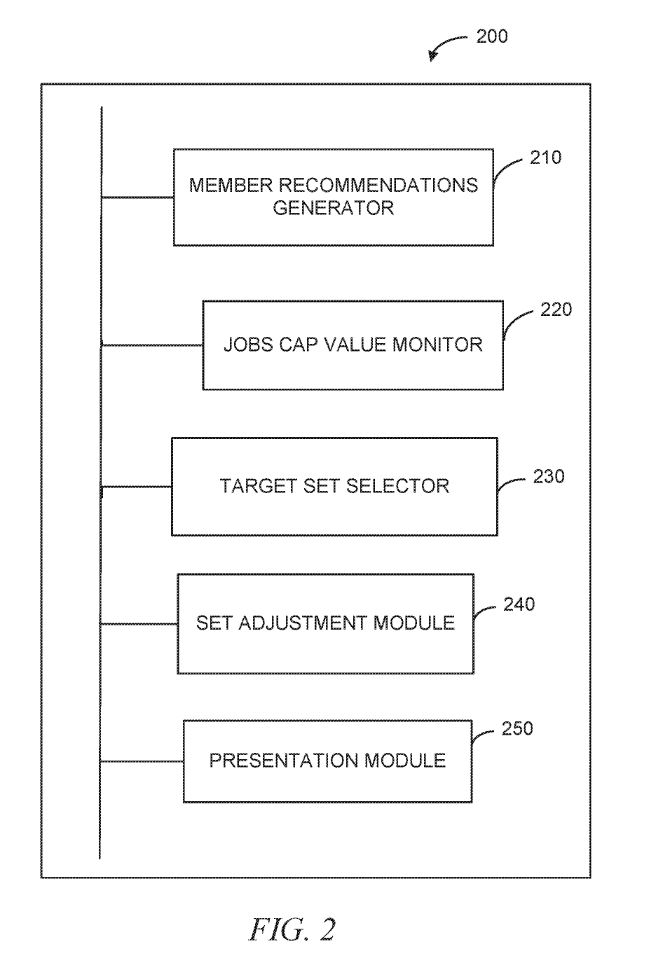

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 is configured to assign/recommend job postings to member profiles and member profiles to job postings simultaneously, using the methodologies described above. An example of an on-line social network system is LinkedIn®. An example recommendation system, which corresponds to the recommendation system 144 is illustrated in FIG. 2.

FIG. 2 is a block diagram of a system 200 to generate joint assignment of job recommendations to members in the on-line social network system 142 of FIG. 1. As shown in FIG. 2, the system 200 includes a member recommendations generator 210, a candidate cap value monitor 220, a target set selector 230, a set adjustment module 240, and a presentation module 250.

The member recommendations generator 210 is configured to generate, for member profiles in a set of member profiles, for job postings in a set of job postings, respective presentation sets of profiles. As explained above, an item in a presentation set of profiles generated for a particular job posting comprising a reference to a member profile representing a member in a web-based system, and an associated fitness value, where the associated fitness value indicating a likelihood that a member represented by the member profile is hired for a job represented by the particular job posting.

In order to generate a target presentation set of profiles, the member recommendations generator 210 accesses a preliminary set of profiles identified for a target job posting, selects a subset of items from the preliminary set of profiles based on their respective fitness values, generates the target presentation set of profiles for a target job posting by identifying the selected subset of items as the target presentation set of profiles, and removes the selected subset of items from the preliminary set of profiles.

The jobs cap value monitor 220 is configured to determine that a subject member profile is referenced in a number of presentation sets of profiles that is greater than a jobs cap value. The jobs cap value indicates the maximum number of job postings to include in a presentation set of job recommendations.

Respective sets of job recommendations for member profiles in a set of member profiles are generated by a job recommendations generator. An an item in a presentation set of job recommendations generated for a particular member profile comprises a reference to a job posting and an associated relevance value. The associated relevance value indicates a likelihood that a member represented by the member profile applies for a job represented by the particular job posting.

The target set selector 230 is configured to select a target presentation set of profiles from those respective presentation sets of profiles that includes a reference to the subject member profile, based on respective fitness values assigned to the subject member profile in the associated presentation sets of profiles.

The set adjustment module 240 is configured to generate a modified target presentation set of profiles by removing a reference to the subject member profile from the target presentation set of profiles. The set adjustment module 240 is also configured to determine that a number of items in the modified target presentation set of profiles is less than a candidates cap value, select an additional item to be included in the modified target presentation set of profiles from the preliminary set of profiles, and remove the additional item from the preliminary set of profiles. In some embodiments, the set adjustment module 240 selects the additional item based on a fitness value assigned to the additional item with respect to the target job posting. Where the items in the preliminary set of profiles are ordered based on their respective fitness values, the set adjustment module selects the additional item by selecting the first item in the preliminary set of profiles. The set adjustment module 240 is also configured to determine that the selected additional item represents a member profile that is referenced in a number of presentation sets of profiles that is greater than the jobs cap value and, in response to the determination, to prevent the additional item from being included in in the modified target presentation set of profiles.

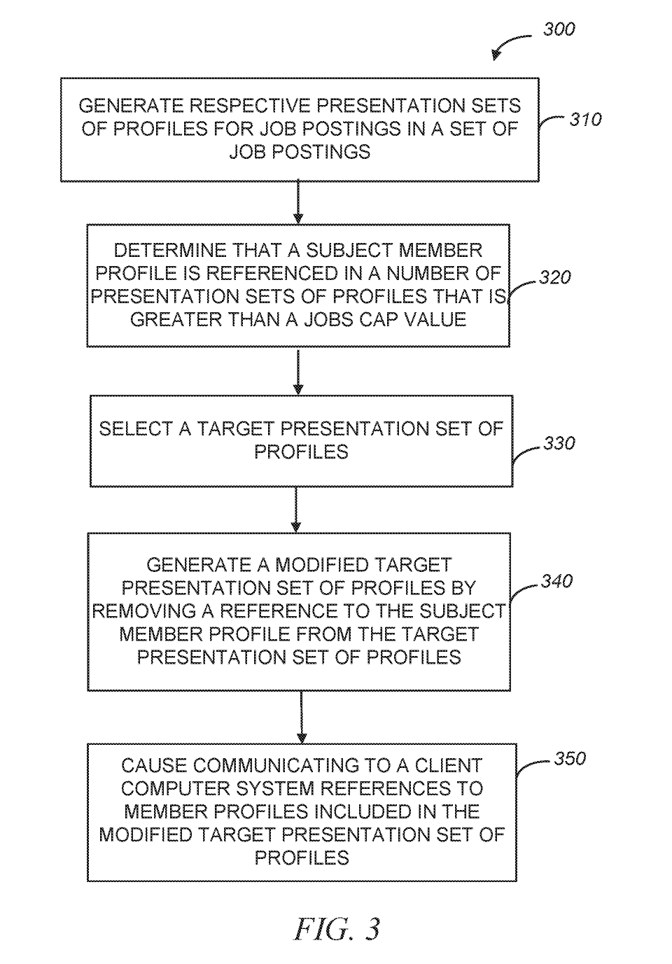

The presentation module 250 is configured to to cause communicating to a client computer system references to member profiles included in the modified target presentation set of profiles. Some operations performed by the system 200 may be described with reference to FIG. 3.

FIG. 3 is a flow chart of a method 300 to generate joint assignment of job recommendations to members in the on-line social network system 142 of FIG. 1 utilizing member profile similarity values generated for job posting with respect to a subject member profile. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the member recommendations generator 210 of FIG. 2 generates, for job postings in a set of job postings, respective presentation sets of profiles. At operation 320, the jobs cap value monitor 220 of FIG. 2 determines that a subject member profile is referenced in a number of presentation sets of profiles that is greater than a jobs cap value. At operation 330, the target set selector 230 of FIG. 2 selects a target presentation set of profiles from those respective presentation sets of profiles that include a reference to the subject member profile, based on respective fitness values assigned to the subject member profile in the associated presentation sets of profiles. The set adjustment module 240 of FIG. 2 generates a modified target presentation set of profiles, at operation 340, by removing a reference to the subject member profile from the target presentation set of profiles. The presentation module 250 of FIG. 2 causes presentation, on a display device, of references to member profiles included in the modified target presentation set of profiles, at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

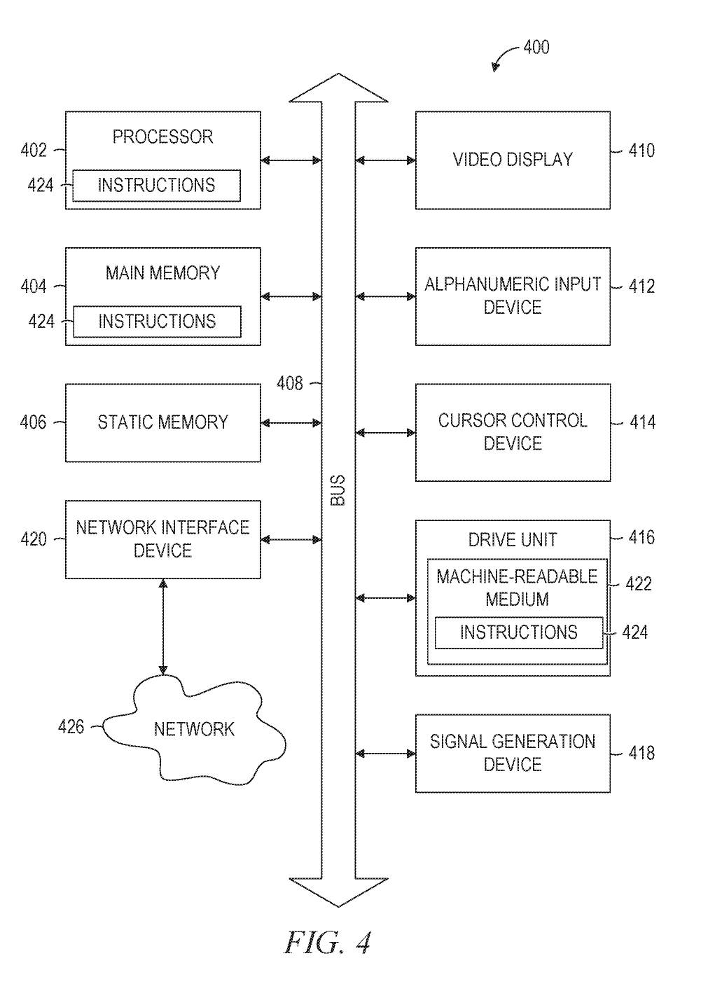

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate joint assignment of member profiles to job postings in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
generating, for job postings in a set of job postings, respective presentation sets of profiles, an item in a presentation set of profiles generated for a particular job posting comprising a reference to a member profile representing a member in a web-based system, and an associated fitness value, the associated fitness value indicating a likelihood that a member represented by the member profile is hired for a job represented by the particular job posting, the job postings in the set of job postings are respective electronic publications stored in a database associated with the web-based system;
determining that a subject member profile is referenced in a number of presentation sets of profiles that is greater than a jobs cap value;
selecting a target presentation set of profiles from those respective presentation sets of profiles that include a reference to the subject member profile, based on respective fitness values assigned to the subject member profile in the associated presentation sets of profiles;
using at least one processor, generating a modified target presentation set of profiles by removing a reference to the subject member profile from the target presentation set of profiles; and
causing communicating to a client computer system references to member profiles included in the modified target presentation set of profiles.

2. The method of claim 1, wherein the jobs cap value indicates the maximum number of job postings to include in a presentation set of job recommendations, the method including:
generating, for member profiles in a set of member profiles, respective presentation sets of job recommendations, an item in a presentation set of job recommendations generated for a particular member profile comprising a reference to a job posting and an associated relevance value, the associated relevance value indicating a likelihood that a member represented by the member profile applies for a job represented by the particular job posting.

3. The method of claim 1, comprising:
accessing a preliminary set of profiles identified for a target job posting;
selecting a subset of items from the preliminary set of profiles based on their respective fitness values;
generating the target presentation set of profiles for a target job posting by identifying the selected subset of items as the target presentation set of profiles; and
removing the selected subset of items from the preliminary set of profiles.

4. The method of claim 3, comprising:
determining that a number of items in the modified target presentation set of profiles is less than a candidates cap value;
from the preliminary set of profiles selecting an additional item to be included in the modified target presentation set of profiles; and
removing the additional item from the preliminary set of profiles.

5. The method of claim 4, wherein the selecting of the additional item is based on a fitness value assigned to the additional item with respect to the target job posting.

6. The method of claim 4, wherein all items in the preliminary set of profiles are ordered based on their respective fitness values,

7. The method of claim 6, wherein the selecting of the additional item is selecting the first item in the preliminary set of profiles.

8. The method of claim 4, comprising:
determining that the selected additional item represents a member profile that is referenced in a number of presentation sets of profiles that is greater than the jobs cap value; and
preventing the additional item from being included in in the modified target presentation set of profiles.

9. The method of claim 4, comprising repeating operations of selecting of an additional item to be included in the modified target presentation set of profiles and removing the additional item from the preliminary set of profiles until: no more items remain in the preliminary set of profiles, or a number of items in the modified target job recommendation equals to the jobs cap value.

10. The method of claim 1, wherein member profiles from the set of member profiles are represented in the on-line social network system by respective web pages.

11. A computer-implemented system comprising:
a member recommendations generator, implemented using at least one processor, to generate, for job postings in a set of job postings, respective presentation sets of profiles, an item in a presentation set of profiles generated for a particular job posting comprising a reference to a member profile representing a member in a web-based system, and an associated fitness value, the associated fitness value indicating a likelihood that a member represented by the member profile is hired for a job represented by the particular job posting, the job postings in the set of job postings are respective electronic publications stored in a database associated with the web-based system;
a jobs cap value monitor, implemented using at least one processor, to determine that a subject member profile is referenced in a number of presentation sets of profiles that is greater than a jobs cap value;
a target set selector, implemented using at least one processor, to select a target presentation set of profiles from those respective presentation sets of profiles that include a reference to the subject member profile, based on respective fitness values assigned to the subject member profile in the associated presentation sets of profiles;
a set adjustment module, implemented using at least one processor, to generate a modified target presentation set of profiles by removing a reference to the subject member profile from the target presentation set of profiles; and
a communication module, implemented using at least one processor, to cause communicating to a client computer system references to member profiles included in the modified target presentation set of profiles.

12. The system of claim 11, wherein the jobs cap value indicates the maximum number of job postings to include in a presentation set of job recommendations, the system including:
a job recommendations generator, implemented using at least one processor, to generate, for member profiles in a set of member profiles, respective presentation sets of job recommendations, an item in a presentation set of job recommendations generated for a particular member profile comprising a reference to a job posting and an associated relevance value, the associated relevance value indicating a likelihood that a member represented by the member profile applies for a job represented by the particular job posting.

13. The system of claim 11, wherein the member recommendations generator is to:
access a preliminary set of profiles identified for a target job posting;
select a subset of items from the preliminary set of profiles based on their respective fitness values;
generate the target presentation set of profiles for a target job posting by identifying the selected subset of items as the target presentation set of profiles; and
remove the selected subset of items from the preliminary set of profiles.

14. The system of claim 13, wherein the set adjustment module is to:
determine that a number of items in the modified target presentation set of profiles is less than a candidates cap value;
from the preliminary set of profiles select an additional item to be included in the modified target presentation set of profiles; and
remove the additional item from the preliminary set of profiles.

15. The system of claim 14, wherein the set adjustment module is to select the additional item based on a fitness value assigned to the additional item with respect to the target job posting.

16. The system of claim 14, wherein all items in the preliminary set of profiles are ordered based on their respective fitness values,

17. The system of claim 16, wherein the set adjustment module is to select the additional item by selecting the first item in the preliminary set of profiles.

18. The system of claim 14, wherein the set adjustment module is to:
determine that the selected additional item represents a member profile that is referenced in a number of presentation sets of profiles that is greater than the jobs cap value; and
prevent the additional item from being included in in the modified target presentation set of profiles.

19. The system of claim 11, wherein member profiles from the set of member profiles are represented in the on-line social network system by respective web pages.

20. A machine-readable non-transitory storage medium having instruction data executable by a machine to cause the machine to perform operations comprising:
generating, for job postings in a set of job postings, respective presentation sets of profiles, an item in a presentation set of profiles generated for a particular job posting comprising a reference to a member profile representing a member in a web-based system, and an associated fitness value, the associated fitness value indicating a likelihood that a member represented by the member profile is hired for a job represented by the particular job posting, the job postings in the set of job postings are respective electronic publications stored in a database associated with the web-based system;
determining that a subject member profile is referenced in a number of presentation sets of profiles that is greater than a jobs cap value;
selecting a target presentation set of profiles from those respective presentation sets of profiles that include a reference to the subject member profile, based on respective fitness values assigned to the subject member profile in the associated presentation sets of profiles;
generating a modified target presentation set of profiles by removing a reference to the subject member profile from the target presentation set of profiles; and
causing communicating to a client computer system references to member profiles included in the modified target presentation set of profiles.
